(19) United States
(12) Patent Application Publication
(10) Pub. No.: US 2008/0230520 A1
(43) Pub. Date: Sep. 25, 2008

(54) Method For Welding Two Rails of a Track

(76) Inventors: Bernhard Lichtberger, Linz (AT); Heinz Muhlleitner, St. Polten-Flinsbach (AT)

Correspondence Address: COLLARD & ROE, P.C., 1077 NORTHERN BOULEVARD, ROSLYN, NY, 11576, US

(21) Appl. No.: 10/574,716

(22) PCT Filed: Nov. 4, 2004
(86) PCT No.: PCT/EP2004/012451

§ 371 Date: Mar. 28, 2006

(30) Foreign Application Priority Data
Nov. 6, 2003 (AT) GM 777/2003

(51) Int. Cl. B23K 11/04; E01B 29/17

(52) U.S. Cl. 219/53; 104/15

(57) ABSTRACT

The invention relates to a method for welding two rails (8, 10, 14) of a track using a welding unit (1) of a welding machine (20). According to the method, two rails (8,10,14) each caught by a pair of clamping jaws (6) of the welding unit (1) are moved and welded together while subjecting them to crusher cylinders (3) in the longitudinal direction of the rails. A rail anchor (16) is produced in a so-called terminal-welding step in a working direction (11) upstream of the machine (20) by linking a section of the rail (14) with ties (15) in a non-positive manner. If the actual rail temperature differs from the local neutral temperature, tensions are passed into the rails to be welded together. The inventive method is characterized in that in parallel to the welding of a—with respect to the working direction of the welding machine (20)—first rail with a second rail (8,10), a pressure force is passed into a front rail end (7) of the second rail (10) in the direction of the first rail (8) by means of a rail pressing device (19) in order to generate a compressive strain, the rail pressing device (19) being supported on a rail anchor (16) of a third rail (14) subsequent to the second rail (10). The first rail (8) is braced with the ties (15) once the welding step is terminated.

The invention relates to a method for welding two rails of a track according to the features cited in the introductory part of claim 1.

Known from U.S. Pat. No. 5,099,097, U.S. Pat. No. 5,136,140, and U.S. Pat. No. 4,929,816, respectively, is a welding unit which, in order to pass increased tensile forces into the rails to be welded together, is equipped with a rail-pulling device. With this, it is possible to also weld long-welded rails below the neutral temperature within the scope of a so-called closure weld.

From an article “Mobile flash-butt rail welding: three decades of experience” in the journal “Rail Engineering International”, Edition 2002/3, pages 11 to 16, it is likewise known to use a rail-pulling device, enclosing the welding unit, for performing closure welds.

It is the object of the present invention to provide a method of the specified kind with which welding of the rails is possible also above the neutral temperature.

According to the invention, this object is achieved with a method of the type mentioned at the beginning by means of the features cited in the characterizing part of claim 1.

With a method of this type, it is possible for the first time to perform the welding operations independently of the prevailing actual temperature. In addition to economic advantages, this also leads to increased safety since it is not necessary now to use temporary fish-plate connectors until the actual temperature is in the neutral range.

Additional advantages and features of the invention become apparent from the further claims and the drawing.

The invention will be described in more detail below with reference to embodiments represented in the drawing in which

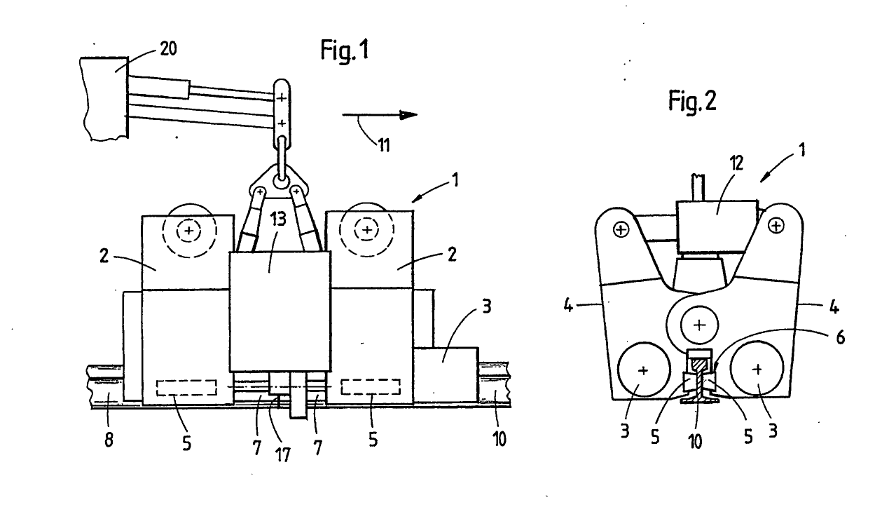

FIGS. 1 and 2 each show a view of a welding unit, and

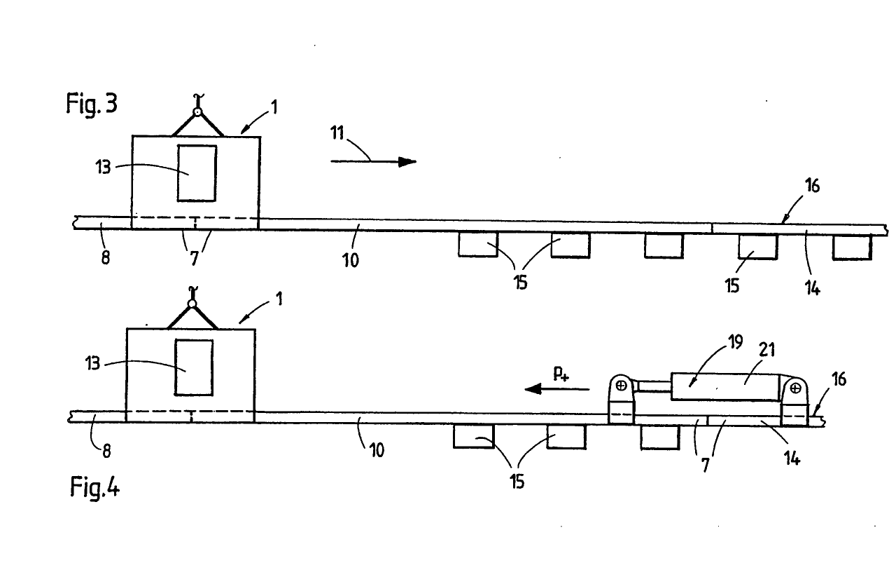

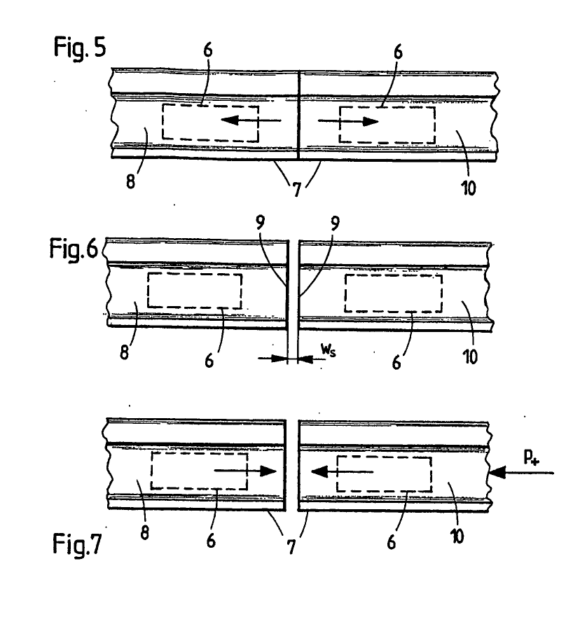

FIGS. 3 to 7 show schematic representations of the welding process.

A welding unit 1, shown in FIGS. 1 and 2, is essentially composed of two unit halves 2, spaced from one another, which are connected to one another by means of compression cylinders 3 arranged in a common horizontal plane and extending parallel to one another, the unit halves 2 being displaceable in the longitudinal direction of the compression cylinders 3. Each of the two unit halves 2 consists of two unit levers 4 which are pivotable towards one another in a pincer-like fashion about an axis extending in the longitudinal direction of the rails and include clamping jaws 5, acting as electrodes, of two pairs 6 of clamping jaws. The latter are provided for application to a front rail end 7 of a first rail 8 and to a rear end 7 of a second rail 10, respectively.

The two unit levers 4,5, lying opposite one another in the transverse direction of the track, are connected to one another in their upper end region by means of a tensioning cylinder 12 for pressing the clamping jaws 5 onto the rails 8,10. The welding unit 1 is suspended from a telescopic crane fastened to a welding machine 20. Energy is supplied by way of a generator, arranged in the welding machine 20, and a hydraulic pump. A control device 13 is provided for performing the welding process and recording various welding parameters.

In a continuously welded track, compressive stresses occur as soon as the actual rail temperature rises above a neutral temperature. If the rail temperature sinks below the neutral temperature, tensile stresses occur. Welding is carried out according to the flash-butt welding method. The rails are welded to form partial sections of about 360 m in length at a rail temperature which is above neutral temperature. The partial sections, which here are named first, second and third rail for the sake of simplicity, are finally connected by so-called closure welds.

If, for instance, the actual rail temperature measured prior to performing the closure weld is 30°, and the neutral temperature is 20°, the following ideal compressive stress results: σₛₒₗₗ=E·α·Δt

E=modulus of elasticity of the rail steel [215000 N/mm²],
Δt=change in temperature [° C.],
α=coefficient of the thermal expansion of the rail material [0.0000115]

σₛₒₗₗ=215000·0.0000115·10=24.73 N/mm²

In the case of a rail of the type UIC 60, having an area of 7686 mm², this results in the following ideal compressive force Fₛₒₗₗ.

Fₛₒₗₗ=24.73·7686=190 074 N or 190 kN (kilo Newton).

After entering the neutral temperature, the actual rail temperature and the rail type into the control device 13, the ideal compressive force is calculated by a microprocessor.

The execution of the method according to the invention will now be described in more detail:

In order to weld the first rail 8—as seen in the working direction 11 of a welding machine 20—to the second rail 10 at a temperature above neutral temperature, it is necessary to first form a rail anchor 16 by bracing a section of a third rail 14, adjoining the second rail 10, with associated sleepers 15 (see FIGS. 3 and 4). With this, a longitudinal movement of the third rail 14 relative to the associated sleepers 15 is precluded. A hydraulic rail-pushing device 19 is force-lockingly brought in contact with the adjoining rail ends 7 of the second and third rail 10,14, while the welding unit 1 is placed over the adjoining rail ends 7 of the first and second rail 8,10 and force-lockingly connected to the two rail ends 7 by means of the clamping jaws 5.

The welding process is initiated in that the two rail ends 7, gripped by the clamping jaws 5, are moved away from one another with actuation of the compression cylinders 3 until adjoining end surfaces 9 of the two rail ends 7 form a welding gap wₛ of 3 millimeters. During this, the force is measured continuously via the pressure in the compression cylinders 3, and also the path is measured via the distance of the two pairs 6 of clamping jaws to one another. After formation of the welding gap wₛ, the actual welding process is started with introduction of current, and the movement of the two pairs 6 of clamping jaws away from one another is reversed into a movement towards one another (see FIG. 7), thus initiating the burn-off phase including the concluding upsetting stroke. According to plan, this movement towards one another is carried out while maintaining a slight distancing of the rail ends 7 from one another and is finally finished at an upsetting force of 30 N/mm² with the upsetting stroke. In this phase, each rail end 7 is shortened by about 17.5 mm. This naturally leads to a drop of the actual rail stress to below the ideal compressive stress.

In order to maintain the ideal compressive stress in spite of said rail shortening, a pressing force P₊—also registered in the control device 13—is passed, parallel to the burn-off phase, by the rail-pushing device 19 in the direction towards the welding unit 1 into the front rail end 7 of the second rail 10 for producing a compressive stress. Due to the frictional resistance, said compressive stress should expediently be slightly greater than the ideal compressive stress. In doing so, the ideal compressive stress is transmitted to the first rail 8 quasi via a force chain formed by the rail anchor 16, the hydraulic cylinder 21 of the rail-pushing device 19, the second rail 2, and the compression cylinders 3. Attainment of the ideal compressive force is registered via the compression cylinders 3 and can be regulated automatically by including the hydraulic cylinder 21 of the rail-pushing device 19. However, it is also possible to control the actuation of the hydraulic cylinder 21 manually, in which case the compressive stress occurring in the region of the welding unit 1 is monitored on a display.

This method ensures that, after termination of the rail welding, the ideal compressive stress correlating to the actual rail temperature exists in the welded rails 8,10. As soon as the first rail 8 has been fully connected (or anchored), as prescribed, to the associated sleepers 15 by tightening the rail fastening means or installing rail clamps, hydraulic cylinders 21 of the rail-pushing device 19 are switched pressure-less. The welding unit 1 may be detached and lifted from the rails 8,10 immediately after removal of a welding burr.

After positioning the welding unit 1 over the two rail ends 7 of the second and third rail 10,14, the latter can be welded to one another with repetition of the steps of the method.

1. A method for welding two rails (8,10,14) of a track using a welding unit (1) of a welding machine (20), wherein two rails (8,10,14), each gripped by a pair (6) of clamping jaws of the welding unit (1), are moved in the longitudinal direction of the rails with actuation of compression cylinders (3) and welded to one another, wherein, in the course of a so-called closure weld, a rail anchor (16) is produced in front of the machine (20), in a working direction (11), by means of a force-locking connection of a section of the rail (14) to sleepers (15) and, if an actual rail temperature differs from a local neutral temperature, stresses are passed into the rails to be welded together, wherein, parallel to the welding of a first rail (8)—with respect to the working direction of the welding machine (20)—to a second rail (10), a compressive force for producing a compressive stress is passed into a front rail end (7) of the second rail (10) by means of a rail-pushing device (19) in the direction towards the first rail (8), the rail-pushing device (19) being supported on a rail anchor (16) of a third rail (14) adjoining the second rail (10), and that, after termination of the welding process, the first rail (8) is braced with the sleepers (15).

2. A method according to claim 1, wherein, in a first phase of the welding process, the pairs (6) of clamping jaws pressed onto the first and second rail (8,10) are distanced from one another until adjacent surfaces (9) of the two rails (8,10) are spaced from one another to form a welding gap Wₛ, and, in a second phase, the pairs (6) of clamping jaws are moved towards one another while current is supplied and, parallel thereto, the compressive force is passed into the second rail (10) by the rail-pushing device (19).

3. A method according to claim 1, wherein the compressive stress produced by the compressive force of the rail-pushing device (19) conforms to at least an ideal compressive stress correlating to the actual rail temperature.

4. A method according to claim 1, wherein the welding unit (1) and the rail-pushing device (19) are controlled synchronously.
